(19) United States
(12) Patent Application Publication
(10) Pub. No.: US 2007/0247145 A1
(43) Pub. Date: Oct. 25, 2007

(54) DEVICE FOR DETECTING DEFECTS ON METALS

(75) Inventor: Bernd ZIMMERMANN, Ihringen (DE)

Correspondence Address: ROBERTS, MLOTKOWSKI & HOBBES, P. O. BOX 10064, MCLEAN, VA, 22102-8064, US

(73) Assignee: PRUEFTECHNIK DIETER BUSCH AG, Ismaning (DE)

(21) Appl. No.: 11/738,136

(22) Filed: Apr. 20, 2007

(30) Foreign Application Priority Data
Apr. 21, 2006 (DE) 10 2006 019 128.5

(51) Int. Cl. G01N 27/82

(52) U.S. Cl. 324/242

(57) ABSTRACT

A stray flux measurement device for detection of defects near the surface and remote from the surface on ferromagnetic specimens (10) is characterized by at least one coil (20) or an equivalently acting core/coil combination that faces the specimen (24, 22) and at least one coil (30, 40) or an equivalently acting core/coil combination (34, 32; 44, 42) that faces at an angle relative to the surface of the specimen.

### BACKGROUND OF THE INVENTION

1. Field of the Invention

This invention relates to a device and process for detecting defects in metal parts and for quantitative assessment of these defects. The invention relates especially to a novel device for detecting these defects by means of nondestructive, electromagnetically-based techniques. In particular, the invention relates to a device for detecting the indicated defects by means of so-called stray flux measurements.

2. Description of Related Art

The known test and measurement devices for detecting defects on metallic raw material and semi-finished products based on stray flux measurements, conventionally, provide for exposing the test specimen, which is generally ferromagnetic, to a relatively strong constant or variable magnetic field. In the absence of defects, this field is routed through the specimen, uniformly to some extent, the magnetic flux being largely homogeneous in space. In the presence of defects in the form of a crack, gap or the like, field portions in the vicinity of the defect are displaced from the metal; this leads to nonuniformities in the field distribution. The displaced magnetic field portions can be detected, as such, with suitable magnetically sensitive probes, for example, coils, Hall probes and the like, and then, typically indicate a defect being present.

However, as popular as the indicated process of stray flux measurement is in the field of nondestructive testing (NDT), it is subject to the problem that is allows better discrimination of defects near the surface and near the probe than those hidden underneath the surface of the material of the specimen. The subsurface defects do cause field displacement and can, in principle, be observed with conventional probes, but the signals produced are of such a low amplitude that they are often in the range of the low frequency noise level.

### SUMMARY OF THE INVENTION

Thus, a primary object of the present invention is to solve the indicated problem and to provide a device and a process with which subsurface faults of the specimen can be better sensed by means of stray flux observation without the sensitivity of the device being reduced for faults near the surface.

The object is achieved in accordance with the invention by a sensor device that comprises the combination of at least one coil or probe which lies flat and at least one coil or probe which is oriented perpendicular thereto. This means that, to detect the stray flux portions, the coil which lies flat has a surface which is oriented parallel to the surface of the specimen, and the coil which is oriented perpendicular thereto has a surface which is directed tangentially to the surface of the specimen and preferably face in the direction of motion of the specimen.

The invention is based on the fact that the known measurement processes with coils which lie flat are well suited to sensing the magnetic field portions emerging normally from the specimen in the vicinity of the defect, but not the rather tangentially emerging magnetic field portions which originate from hidden defects. A coil or probe which is oriented perpendicular thereto with a surface facing in the direction of motion of the specimen is much better suited thereto and produces much higher signals even if they are of lower frequency than the signals recorded in the presence of defects by the coil which lies flat.

The invention is explained in detail below with reference to the accompanying drawings.

### BRIEF DESCRIPTION OF THE DRAWINGS

FIG. 1 schematically shows a ferromagnetic specimen being moved past a device in accordance with the present invention in the practice of the process of the present invention;

FIG. 2 is a schematic side view of modified embodiment of the device and process of the present invention; and

FIG. 3 shows how the field lines run for a tubular specimen and use of the device of the invention for detection thereof.

### DETAILED DESCRIPTION OF THE INVENTION

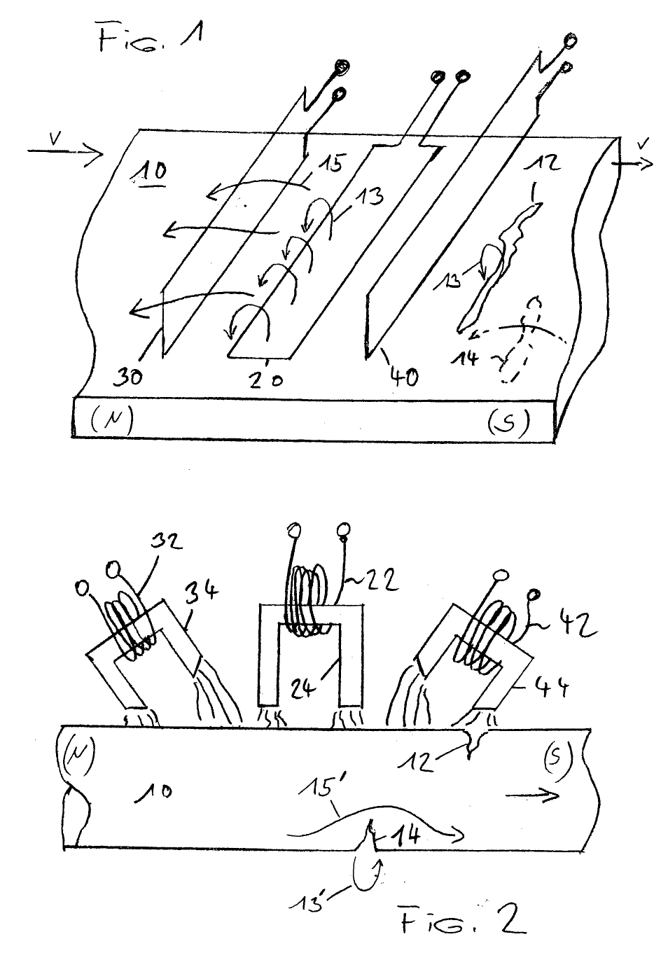

FIG. 1 schematically shows a ferromagnetic specimen 10 with its direction of motion illustrated by the arrows “v”. The specimen is penetrated lengthwise by a constant field as is symbolized by the letters N and S; however, the polarity of the field is generally unimportant. A defect 12 near the surface causes displaced field lines 13 with relatively steep exit angles. A hidden defect 14 which lies under the surface causes displaced field lines 15 with relative flat exit angles. The field lines 13 are suited to producing a detectable signal in the coil or probe 20. The field lines 15 are suited to producing a detectable signal in the coil 30 or in the coil 40. The coils or probes 20, 30, 40 are shown in FIG. 1 schematically as coreless and single-layer coils with only one turn and are, in practice, are provided with additional turns.

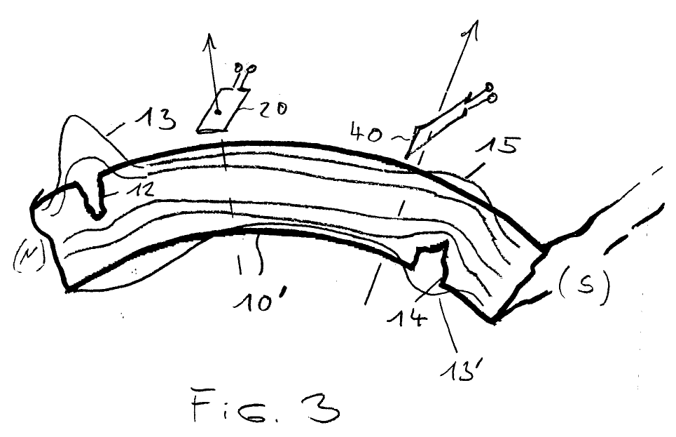

FIG. 2 shows a similar arrangement in which the coils 22, 32, 34 are provided with cores 24, 34, 44. However, in this connection, the combination of a coil 22 and a core 24 is suited to producing a detectable signal in the presence of field lines 15 as are caused, for example, by a hidden defect 14 at a certain distance. The other coil/core combinations from FIG. 2 are designed to also, and preferably, detect field lines 13, optionally, with time storage of the assorted signals and their subsequent analysis by means of suitable electronics and a computer.

It goes without saying that the signal delivered by the coils 22, 32, 42 should be supplied to an amplifier and a following signal conditioning unit in order to obtain reliable indications of defects which are present. Likewise, it goes without saying that the coils must be suitably fastened relative to one another, and advantageously, are accommodated in a suitable housing which is spaced suitably away from the specimen.

FIG. 3 shows how the field lines run for a tubular specimen in a schematic appearance, in the case of a stray flux measurement arrangement. The defect 12 near the surface displaces the field lines which normally run roughly parallel to the surface, causing steeply emerging field lines 13 which are suited to producing a detectable signal in the coil 20. The hidden defect 14 displaces the normally parallel running field lines radially outward on the surface as field lines 15 which emerge relatively flat and which are suited to producing a detectable signal in the coil 40.

What is claimed is:

1. Stray flux measurement device for detection of faults or defects near and remote from a surface of a ferromagnetic specimen, comprising:
at least one first coil or an equivalently acting core/coil combination disposed for facing the surface of the ferromagnetic specimen so as to be particularly suited for detecting surface faults or defects; and
at least one second coil or an equivalently acting core/coil combination disposed for facing at an angle to the surface of the ferromagnetic specimen so as to be particularly suited for detecting subsurface faults or defects.

2. Stray flux measurement device according to claim 1, wherein the at least one second coil or equivalently acting core/coil combination is arranged perpendicular to the at least one first coil or equivalently acting core/coil combination.

3. Stray flux measurement device according to claim 1, wherein the at least one second coil or equivalently acting core/coil combination comprises two second coils or equivalently acting core/coil combinations, each of which is oppositely angled toward the other.

4. Process of detection of faults or defects near and remote from a surface of a ferromagnetic specimen, comprising the steps of:
arranging at least one first coil or an equivalently acting core/coil combination disposed so that surface normals thereof are roughly parallel to the surface of the ferromagnetic specimen; and
arranging at least one second coil or an equivalently acting core/coil combination disposed facing at an angle to the surface of the ferromagnetic specimen;
moving the ferromagnetic specimen passed the first and second coil or an equivalently acting core/coil combinations;
using the at least one first coil or equivalently acting core/coil combination for detecting surface faults and using that at least one second coil or equivalently acting core/coil combination defects for detecting subsurface faults or defects.

5. Process of detection of faults or defects according to claim 4, wherein the step of arranging at least one second coil or an equivalently acting core/coil combination is performed so that surface normals thereof are substantially perpendicular to the surface of the specimen and are oriented in a direction of movement of the specimen.

6. Process of detection of faults or defects according to claim 4, wherein the step of arranging at least one second coil or an equivalently acting core/coil combination is performed by arranging two second coils or an equivalently acting core/coil combinations is so that surface normals thereof are oriented at opposite angles relative to a direction of movement of the specimen.
